(19) United States
(12) Patent Application Publication
(10) Pub. No.: US 2021/0216942 A1
(43) Pub. Date: Jul. 15, 2021

(54) ASSESSING AN INDIVIDUAL'S COMPETENCIES THROUGH SOCIAL NETWORK ANALYSIS

(71) Applicant: INTERNATIONAL BUSINESS MACHINES CORPORATION, ARMONK, NY (US)

(72) Inventors: AL CHAKRA, Apen, NC (US); FAISAL GHAFFAR, Dunboyne (IE); STEPHEN MITCHELL, Chapel Hill, NC (US)

(21) Appl. No.: 16/739,261

(22) Filed: Jan. 10, 2020

(51) Int. Cl. G06Q 10/06; G06Q 50/00

(52) U.S. Cl. CPC G06Q 10/06398; G06Q 50/01

(57) ABSTRACT

Aspects of the invention include a computer-implemented method including extracting, by a processor, a component of an identified competency from an underlying competency framework and creating, by the processor, a list of social networking elements associated with the extracted component of the identified competency. The method analyzes, by the processor, the created list of social networking elements of a social network of an individual using structural analysis and content analysis and combines, by the processor, the structural analysis and the content analysis in a model to determine a score for the individual for the component of the identified competency.

### BACKGROUND

The present invention generally relates to skills analysis, and more specifically, to assessing an individual's core competencies through social network analysis.

Leadership competencies are regularly identified as some of the most in-demand workplace competencies. Competencies are usually subjectively assessed by other managers, peers, or by self-assessment. It is increasingly important to accurately identify each individual's core competencies.

### SUMMARY

Embodiments of the present invention are directed to assessing an individual's core competencies through social network analysis. A non-limiting example computer-implemented method includes extracting, by a processor, behavioral component(s) of an identified competency from an underlying competency framework and creating, by the processor, a list of social networking elements associated with the extracted component of the identified competency. The method analyzes, by the processor, the created list of social networking elements of a social network of an individual using structural analysis and content analysis and combines, by the processor, the structural analysis and the content analysis in a model to determine a score for the individual for the component of the identified competency.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a competency assessment method is generally shown in accordance with one or more embodiments of the present invention;

FIG. 2 illustrates a method to build a repository with social elements related to competency behavior in accordance with one or more embodiments of the present invention;

FIG. 3 depicts a cloud computing environment according to one or more embodiments of the present invention;

FIG. 4 depicts abstraction model layers according to one or more embodiments of the present invention; and

FIG. 5 depicts a computer system in accordance with one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

One or more embodiments of the present invention provide systems and methods of assessment of an individual's leadership competencies using social networks. The method determines an individual's leadership competency through their use of social media. The method determines the networking pattern of individuals on a social network graph. The social patterns can include a set of network measures such as, but not limited to, in-degree, out-degree, centrality measures (e.g., closeness, betweenness) as well as an individual's behavior of interactions (e.g., is the individual an initiator of the interaction or is he the follower). The method then correlates social patterns with behaviors expected from an individual with the leadership competency using any competency model (e.g., Bartram's Great Eight model or ESCO (European Commission: European Skills, Competences, Qualifications and Occupations, https://ec.europa.eu/esco/portal/home)). The disclosed method leverages a competency score from existing assessment methods to build a repository with social elements that can be associated with behavior repertoire aspects of a competency.

It is important that the assessment of leadership competency have reliability, validity, objectivity, and feasibility in assessments. Further requirements include the need for assessments to be clear and consistent; technically sound and that they use valid and reliable observations, data, and inferences. The use of social network analysis to assess transversal competencies addresses several of these requirements, as well as the challenges faced by existing approaches. Its objectivity is highly desirable, especially in light of the prevalence of subjective manager observations.

In several instances social network analysis has been used to identify attributes of groups (explicit and latent) that impact overall task performance. These attributes can be derived from various network metrics. It was found that direct ties among team members positively influence innovation output of teams. The calculation of clusters and cliques can be used to identify cohesion, a central component of collaborative learning, whereas the use of network density and out-degree centralization was also found to indicate cohesion.

Despite the limited research in this area, social network analysis for the assessment of leadership competency has been validated and hence can be adopted as a direct assessment of an individual's leadership competency. Furthermore, social networks are the sources of evidence to capture an individual's characteristics from heterogeneous social interactions.

Social network analysis uses multiple measures, including, but not limited to: degree centrality, betweenness centrality, closeness, EigenCentrality, and PageRank. Degree centrality assigns an importance score based purely on the number of links held by each individual in the network. Betweenness centrality measures the number of times a node lies on the shortest path between other nodes. Closeness scores each node based on its “closeness” to all other nodes within the network. Like degree centrality, EigenCentrality measures a node's influence based on the number of links it has to other nodes within the network. EigenCentrality then goes a step further by also taking into account how well connected a node is, and how many links its connections have, and so on through the network. PageRank is a variant of EigenCentrality, also assigning nodes a score based on their connections, and their connections' connections. The difference is that PageRank also takes link direction and weight into account so that links can only pass influence in one direction and pass different amounts of influence.

An individual's influence within a social network could be quantified by metrics that reflect the network's “positive” response to an individual's posting activity. For example, postings on a workplace collaboration tool such as Slack® or MatterMost® can generate a positive response (a thumbs-up emoji, a thread discussing the issue at hand, or a combination of the two), a negative response (thumbs down emoji, angry face emoji, no discussion of the issue that is posted about), or no response at all. The number of responses would also need to be scaled to reflect the number of people on the network (i.e., 50 positive responses in a network of 100 is more indicative of the validity of a response than 50 positive responses in a network of 10,000). Measuring positive responses to postings provides evidence of using a social network in a manner that is conducive to the workplace collaboration goals of a team and could thus be seen as evidence of leadership traits and qualities.

The competency assessment methods for a twenty-first century workforce needs to take into account the social dimension of individual characteristics and social behaviors. The research has shown that social networks influence individual's behavior, and today's competency assessment system lacks this social evidence of one's competency.

One or more embodiments of the present invention provide technological improvements over current methods of competency analysis that do not include any type of social network analysis. Disadvantages of contemporary approaches may include relying on self-assessments that do not provide a full picture of an individual's qualities. Prior methods do not provide a full system and method to augment existing competency assessment methods with assessment through social network analysis. Assessments are used that are often either highly subjective (e.g. manager appraisals) or prohibitively expensive (e.g. roleplays with trained actors). Moreover, these assessments are often performed periodically and with little consideration for when leadership behaviors are actually exhibited. The increasing usage of workplace social networks and the increasing prevalence of digital collaboration tools present a continuous stream of social interactions that can contain evidence of leadership occurring in situ.

One or more embodiments of the present invention provide technical solutions to one or more of these disadvantages of existing solutions by providing a computerized analysis of an individual's social network, through both a structural analysis and a content analysis. Structural analysis is not possible through pen and paper as the volume of social networking connections may comprise hundreds or thousands of connections that would overwhelm any type of manual assessment. Similarly, it is not possible to manually comb through thousands or tens of thousands of social media interactions.

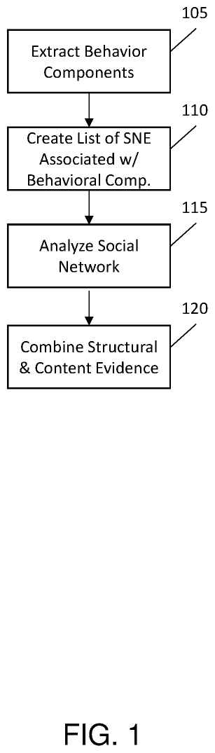

Turning now to FIG. 1, a competency assessment method is generally shown in accordance with one or more embodiments of the present invention. The method will be demonstrated herein with respect to one exemplary competency, Leadership. The method initially extracts a behavior component of leadership competency from an underlying competency framework, such as Bartram's Universal Competency Framework, at block 105. Competency related components may be termed topic labels. For example, “Leading & Deciding” is one competency cluster related to leadership competency. It is defined in Bartram's model as “Takes control and exercises leadership, initiates action, gives direction, and takes responsibility.” The cluster includes “leadership,” depicted in task-competencies, and its associated components from Bartram's Great Eight model as: coaching; delegating; taking initiative and responsibility; motivating others; and providing direction and coordinating actions, for example.

These behavioral components of a competency are subjective to each competency model or framework under observation. For example, one corporation defines leadership competency through behaviors someone exhibits at leadership positions and examples of leadership behavior include, for example, “inspire cohesiveness in the organization” and “promotes efficacy through monitoring, coaching and motivating subordinates” which can be mapped directly to Bartram's model. Advanced neuro-linguistic programming techniques can be leveraged to extract the behavioral aspect of a particular competency from its text.

At block 110, the method creates a list of social networking elements that can be associated with or can represent the behavioral components of a competency. For example, a person who mostly initiates a friend request indicates the behavior of someone who takes initiative and is related to the “taking initiative” component from Bartram's model. Another example is diversity in the connections being an indicator of leading and deciding. An alternative approach is to infer the social elements by first calculating the competency score using traditional assessment methods and then studying the social network of individuals at various proficiency levels of competency. For example, competency scores can be calculated for a range of individuals who are then broken into various proficiency levels. Social elements are then inferred based on the social elements present for the higher proficiency individuals.

The method analyzes the social network of individuals from two perspectives: structure analysis and content analysis at block 115. Structural analysis is where the network is investigated to calculate network measures, such as closeness, degree, constraint (a measure of how much other people know each other), and efficiency (how efficiently the network exchanges information). Content analysis is where social media content is processed using neuro-linguistic processing to associate competency behaviors with the content. Topic modelling techniques are leveraged to measure the similarities between leadership competency behavior statements and social media posts.

At block 120, the social network structural analysis and content analysis is combined for a particular competency in a model, such as a regression model. For example,

(Leading & deciding)_{SNA}=∫β₁x₁+β₂x₂+ . . . +βₖxₖ+ϵ

where, βₖ are scaling factors, xₖ are network structural or content related social elements associated with (Leading & Deciding) competency, and ϵ is an error factor.

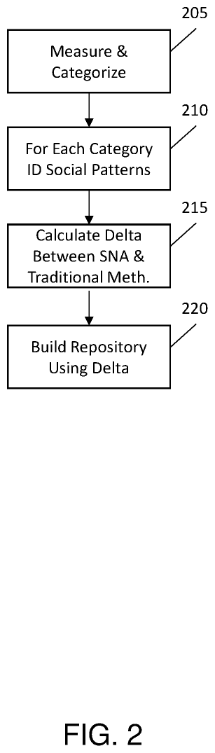

FIG. 2 illustrates a method to build a repository with social elements related to competency behavior in accordance with one or more embodiments of the present invention. Using, traditional assessment methods the method measures each component and categorizes individuals based on component scores at block 205. For example, using personality questionnaires, or peer assessment, the method distinguishes individuals who take initiatives and initiate actions from those who do not. For a more finely grained analysis, individuals can be categorized according to proficiency levels (1 to 5) of their competencies.

For each category, the method studies their social network to identify social patterns, for example, centrality measures, influence scores, and network efficiency, that differentiate each group from others according to the methodology described with respect to FIG. 1 above at block 210. The method calculates the difference, or delta, in leading and deciding scores from social network analysis from the scores obtained from traditional methods at block 215. The method uses this delta to build a repository with variable related social networking of individuals who exhibit the behavior of a particular competency cluster at block 220. The accuracy of the repository may be validated by a human resources expert.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

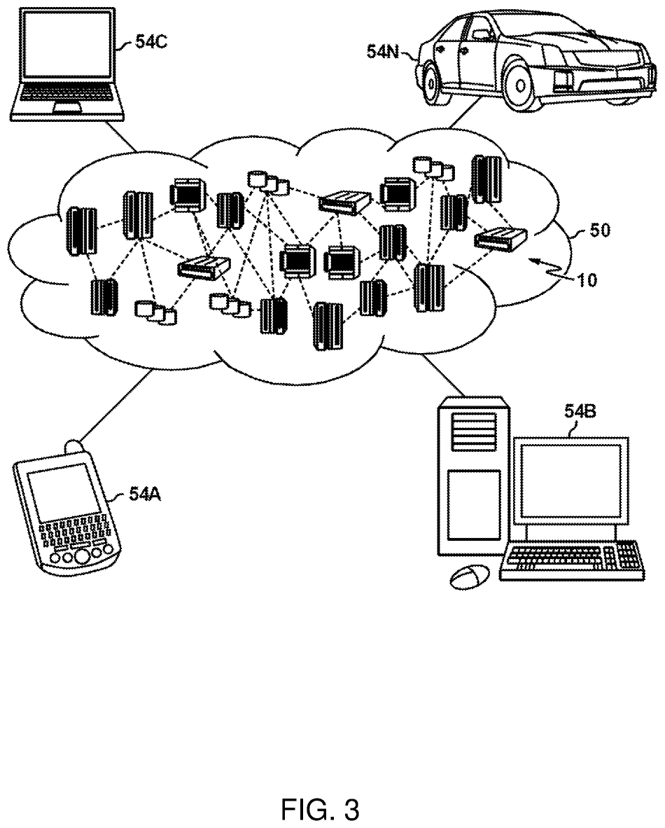

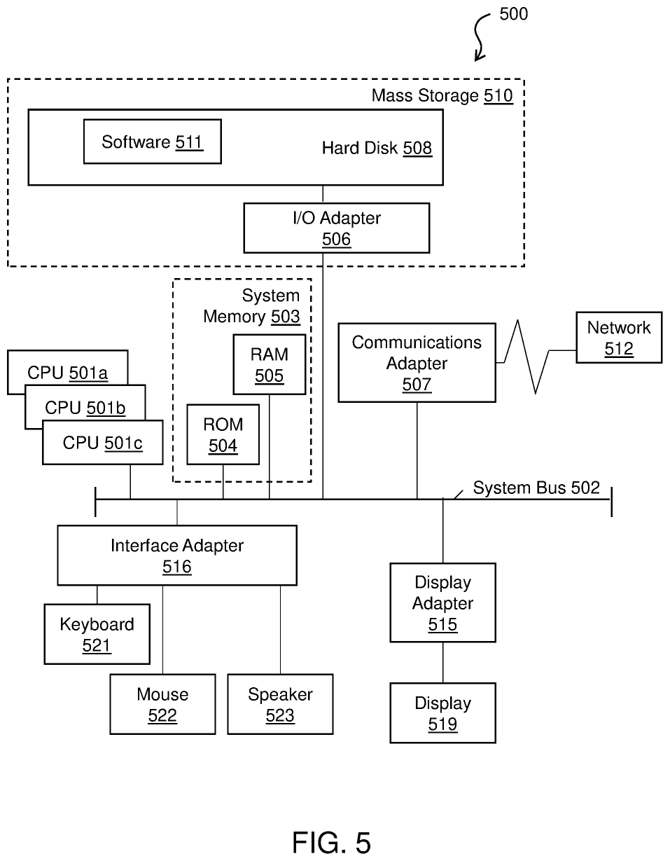

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

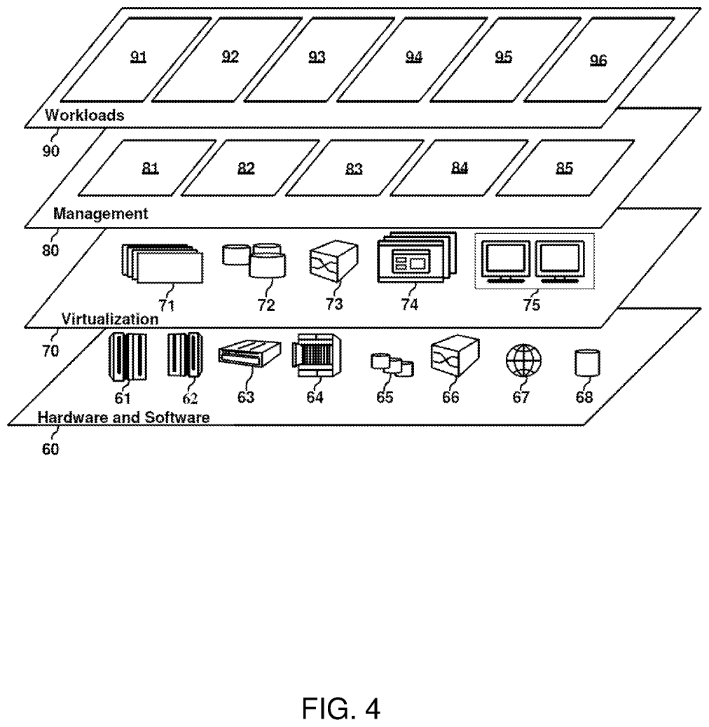

Referring now to FIG. 4, a set of functional abstraction layers provided by cloud computing environment 50 (FIG. 3) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Secure service container-based virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and competency assessment

Turning now to FIG. 5, a computer system 500 is generally shown in accordance with an embodiment. The computer system 500 can be an electronic, computer framework comprising and/or employing any number and combination of computing devices and networks utilizing various communication technologies, as described herein. The computer system 500 can be easily scalable, extensible, and modular, with the ability to change to different services or reconfigure some features independently of others. The computer system 500 may be, for example, a server, desktop computer, laptop computer, tablet computer, or smartphone. In some examples, computer system 500 may be a cloud computing node. Computer system 500 may be described in the general context of computer system executable instructions, such as program modules, being executed by a computer system. Generally, program modules may include routines, programs, objects, components, logic, data structures, and so on that perform particular tasks or implement particular abstract data types. Computer system 500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, the computer system 500 has one or more central processing units (CPU(s)) 501a, 501b, 501c, etc. (collectively or generically referred to as processor(s) 501). The processors 501 can be a single-core processor, multi-core processor, computing cluster, or any number of other configurations. The processors 501, also referred to as processing circuits, are coupled via a system bus 502 to a system memory 503 and various other components. The system memory 503 can include a read only memory (ROM) 504 and a random access memory (RAM) 505. The ROM 504 is coupled to the system bus 502 and may include a basic input/output system (BIOS), which controls certain basic functions of the computer system 500. The RAM is read-write memory coupled to the system bus 502 for use by the processors 501. The system memory 503 provides temporary memory space for operations of said instructions during operation. The system memory 503 can include random access memory (RAM), read only memory, flash memory, or any other suitable memory systems.

The computer system 500 comprises an input/output (I/O) adapter 506 and a communications adapter 507 coupled to the system bus 502. The I/O adapter 506 may be a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 may be stored in the mass storage 510. The mass storage 510 is an example of a tangible storage medium readable by the processors 501, where the software 511 is stored as instructions for execution by the processors 501 to cause the computer system 500 to operate, such as is described herein below with respect to the various Figures. Examples of computer program product and the execution of such instruction is discussed herein in more detail. The communications adapter 507 interconnects the system bus 502 with a network 512, which may be an outside network, enabling the computer system 500 to communicate with other such systems. In one embodiment, a portion of the system memory 503 and the mass storage 510 collectively store an operating system, which may be any appropriate operating system, such as the z/OS or AIX operating system from IBM Corporation, to coordinate the functions of the various components shown in FIG. 5.

Additional input/output devices are shown as connected to the system bus 502 via a display adapter 519 and an interface adapter 516 and. In one embodiment, the adapters 506, 507, 515, and 516 may be connected to one or more I/O buses that are connected to the system bus 502 via an intermediate bus bridge (not shown). A display 519 (e.g., a screen or a display monitor) is connected to the system bus 502 by a display adapter 515, which may include a graphics controller to improve the performance of graphics intensive applications and a video controller. A keyboard 521, a mouse 522, a speaker 523, etc. can be interconnected to the system bus 502 via the interface adapter 516, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 5, the computer system 500 includes processing capability in the form of the processors 501, and, storage capability including the system memory 503 and the mass storage 510, input means such as the keyboard 521 and the mouse 522, and output capability including the speaker 523 and the display 519.

In some embodiments, the communications adapter 507 can transmit data using any suitable interface or protocol, such as the internet small computer system interface, among others. The network 512 may be a cellular network, a radio network, a wide area network (WAN), a local area network (LAN), or the Internet, among others. An external computing device may connect to the computer system 500 through the network 512. In some examples, an external computing device may be an external webserver or a cloud computing node.

It is to be understood that the block diagram of FIG. 5 is not intended to indicate that the computer system 500 is to include all of the components shown in FIG. 5. Rather, the computer system 500 can include any appropriate fewer or additional components not illustrated in FIG. 5 (e.g., additional memory components, embedded controllers, modules, additional network interfaces, etc.). Further, the embodiments described herein with respect to computer system 500 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
extracting, by a processor, a component of an identified competency from an underlying competency framework;
creating, by the processor, a list of social networking elements associated with the extracted component of the identified competency;
analyzing, by the processor, the created list of social networking elements of a social network of an individual using structural analysis and content analysis;
combining, by the processor, the structural analysis and the content analysis in a model to determine a score for the individual for the extracted component of the identified competency.

2. The computer-implemented method of claim 1, wherein creating a list of social networking elements comprises inferring the list of social networking elements by calculating, by the processor, a competency score and comparing the competency score to other individuals at various proficiency levels.

3. The computer-implemented method of claim 1, wherein the structural analysis comprises calculating, by the processor, network measures.

4. The computer-implemented method of claim 3, wherein the network measures are selected from the group consisting of closeness, in-degree, constraint, and efficiency.

5. The computer implemented method of claim 1, wherein the content analysis comprises calculating, by the processor, using neuro-linguistic processing to associate the list of social networking elements with content.

6. The computer-implemented method of claim 1, wherein the created list is secured.

7. The computer-implemented method of claim 1, wherein analyzing the social network further comprises using topic modelling techniques to measure similarities between social media posts and the extracted component of the identified competency.

8. A system comprising:
a memory having computer readable instructions; and
one or more processors for executing the computer readable instructions, the computer readable instructions controlling the one or more processors to perform operations comprising:
extracting a component of an identified competency from an underlying competency framework;
creating a list of social networking elements associated with the extracted component of the identified competency;
analyzing the created list of social networking elements of a social network of an individual using structural analysis and content analysis;
combining the structural analysis and the content analysis in a model to determine a score for the individual for the extracted component of the identified competency.

9. The system of claim 8, wherein creating a list of social networking elements comprising inferring the list of social networking elements by calculating a competency score and comparing the competency score to other individuals at various proficiency levels.

10. The system of claim 8, wherein the structural analysis comprises calculating, by the processor, network measures.

11. The system of claim 10, wherein the network measures are selected from the group consisting of closeness, in-degree, constraint, and efficiency.

12. The system of claim 8, wherein the content analysis comprises calculating using neuro-linguistic processing to associate the list of social networking elements with content.

13. The system of claim 8, wherein combining the structural analysis and the content analysis in a model uses a regression model.

14. The system of claim 8, wherein analyzing the social network further comprises using topic modelling techniques to measure similarities between social media posts and the extracted component of the identified competency.

15. A computer program product comprising one or more computer readable storage media having program instructions embodied therewith, the program instructions executable by a processor to cause the processor to perform operations comprising:
extracting a component of an identified competency from an underlying competency framework;
creating a list of social networking elements associated with the extracted component of the identified competency;
analyzing the created list of social networking elements of a social network of an individual using structural analysis and content analysis;
combining the structural analysis and the content analysis in a model to determine a score for the individual for the extracted component of the identified competency.

16. The computer program product of claim 15, wherein creating a list of social networking elements comprises inferring the list of social networking elements by calculating a competency score and comparing the competency score to other individuals at various proficiency levels.

17. The computer program product of claim 15, wherein the structural analysis comprises calculating, by the processor, network measures.

18. The computer program product of claim 17, wherein the network measures are selected from the group consisting of closeness, in-degree, constraint, and efficiency.

19. The computer program product of claim 15, wherein the content analysis comprises calculating using neuro-linguistic processing to associate the list of social networking elements with content.

20. The computer program product of claim 15, wherein combining the structural analysis and the content analysis in a model uses a regression model.
